(19) United States
(12) Patent Application Publication
(10) Pub. No.: US 2025/0300440 A1
(43) Pub. Date: Sep. 25, 2025

(54) SELF RETAINING CABLE GLAND ARMOR STOP

(71) Applicant: Hubbell Incorporated, Shelton, CT (US)

(72) Inventor: Nicholas Adam SANTORO, Edwardsville, IL (US)

(21) Appl. No.: 19/086,262

(22) Filed: Mar. 21, 2025

Related U.S. Application Data
(60) Provisional application No. 63/569,410, filed on Mar. 25, 2024.

(51) Int. Cl. H02G 3/06

(52) U.S. Cl. CPC H02G 3/0666

(57) ABSTRACT

An armor stop, and a cable gland including an entry component including lower opening, an upper opening, and a channel defined between the lower opening and the upper opening, the armor stop removably engaged in the channel through the lower opening of the entry component, the armor stop having an elongated body with a distal end, a proximal end, and at least one slot extending at least partially along a length of body, wherein the proximal end of the armor stop is compressible, by means of the slot, in a lateral direction to insert and remove the armor stop from the lower opening of the channel.

### FIELD OF THE INVENTION

The present disclosure relates to cable glands, and more particularly, to a self-retaining and removable armor stop.

### BACKGROUND

Cable gland assemblies are commonly used for sealing around a cable or conduit passing through an opening in a wall or bulkhead, particularly in hazardous environments. For example, cable gland assemblies may be used to seal around a cable entering an enclosure, such as a junction box containing electrical equipment. The cable gland prevents fluids entering or exiting the enclosure and provides a flame-proof path to contain any explosion occurring within the junction block.

A cable gland generally includes an entry component removably connected to a middle nut. The entry component typically has an interior surface with an abutment for receiving an armor stop. The armor stop prevents small cables from passing through the cable gland when installed. Typically a washer is used as the armor stop and is installed internally to the cable gland. If a customer does not need the armor stop for the cable they are using, they must disassemble the gland to remove the armor stop.

There is a need for improved armor stops and cable glands employing the same. The present invention solves these and other problems in the prior art.

### SUMMARY

An object of the present invention is to provide a cable gland including an armor stop that is readily removable without disassembly of the cable gland.

In one exemplary embodiment, a cable gland is provided, including an entry component including lower opening, an upper opening, and a channel defined between the lower opening and the upper opening and an armor stop removably engaged in the channel through the lower opening of the entry component, the armor stop having an elongated hollow body with a distal end, a proximal end, and at least one slot extending at least partially along a length of body, wherein the proximal end of the armor stop is compressible, by means of the slot, in a lateral direction to insert and remove the armor stop from the lower opening of the channel.

In some embodiments, the armor stop has at least one rib on an outer surface of the body, and the channel of the entry component includes an annular groove configured to receive the at least one rib. The at least one rib may extend up to ninety degrees around the circumference of the outer surface of the armor stop or up to fifty degrees around the circumference. The at least one rib may include a first rib on a first side of the armor stop and a second rib on a second side of the armor stop opposite the first side.

In some embodiments, the slot has a width that decreases along a length of the slot. The proximal end of the armor stop may have an outer diameter greater than an outer diameter of the body which defines a step between the proximal end and the body. A diameter of the proximal end of the armor stop may be compressible up to twenty-five percent or more.

In some embodiments, the cable gland includes at least one of a middle nut removably connected to the entry component, a back nut removably connected to the middle nut, and an ingress seal compressible between the back nut and the middle nut.

Further provided is armor stop for a cable gland, including an elongated hollow body with a distal end, a proximal end, and at least one slot extending at least partially along a length of body, wherein the proximal end of the armor stop is compressible, by means of the slot, in a lateral direction to insert and remove the armor stop from a lower opening of the cable gland. The armor stop may include at least one rib on an outer surface of the body configured to engage within a corresponding annular groove within the cable gland. In some embodiments, the at least one rib includes a first rib on a first side of the armor stop and a second rib on a second side of the armor stop opposite the first side, each of the first rib and the second rib extending up to ninety degrees around a circumference of the outer surface of the armor stop. In some embodiments, the proximal end of the armor stop has an outer diameter greater than an outer diameter of a central portion of the body defining a step between the proximal end and the central portion of the body.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is an isometric view of cable gland according to an exemplary embodiment of the present disclosure;

FIG. 2A is a side view of the cable gland shown in FIG. 1;

FIG. 2B is another side view of the cable gland shown in FIG. 1;

FIG. 3A is an isometric view of an armor stop according to an exemplary embodiment of the present disclosure in an uncompressed state;

FIG. 3B is a side view of the armor stop shown in FIG. 3A;

FIG. 3C is a bottom view of the armor stop shown in FIG. 3A;

FIG. 4A is an isometric view of an armor stop according to an exemplary embodiment of the present disclosure in a compressed state;

FIG. 4B is a side view of the armor stop shown in FIG. 4A;

FIG. 4C is a bottom view of the armor stop shown in FIG. 4A;

FIG. 5A is a side cutaway view of a cable gland including an armor stop according to an exemplary embodiment of the present disclosure in an uncompressed state;

FIG. 5B is a side cutaway view of the cable gland shown in FIG. 5A with the armor stop in a compressed state; and

FIG. 5C is a side cutaway view of the cable gland shown in FIG. 5A with the armor stop in a compressed state and partially removed.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions, or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

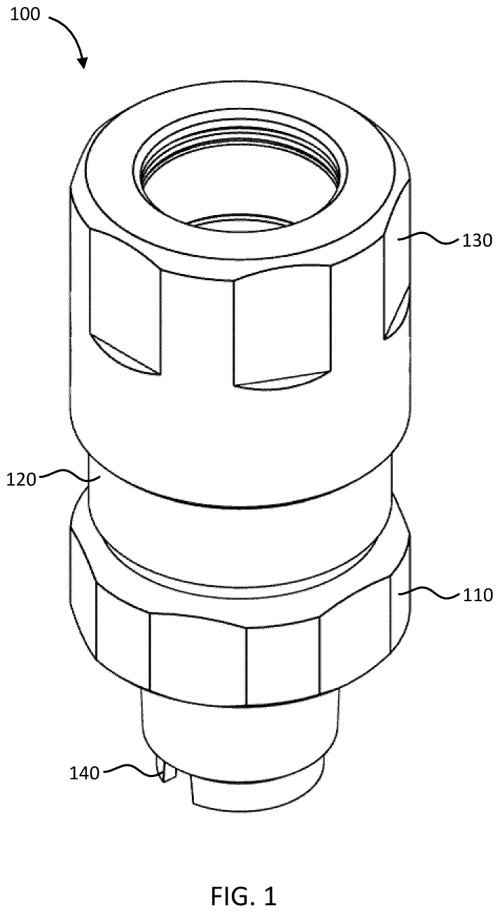

FIG. 1 shows a cable gland 100 according to an exemplary embodiment of the present disclosure. The cable gland 100 includes an entry component 110, a middle nut 120, and a back nut 130. In the exemplary embodiment, the middle nut 120 is secured to the entry component 110 and the back nut 130 via threaded engagements.

The cable gland 100 is adapted to receive at least one or plurality of cables extending therethrough. Each of the entry component 110, the middle nut 120, and the back nut 130 are hollow and define a central channel for the cables. The cables may be electrical cables, including armored electrical cables, though the invention is not limited thereto. In some embodiments, the cables may be data cables such as fiber optic or Ethernet cables.

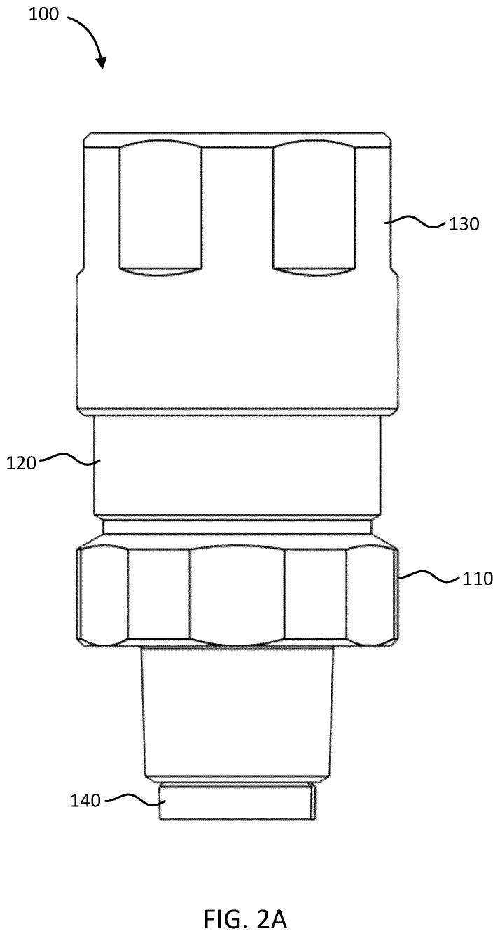

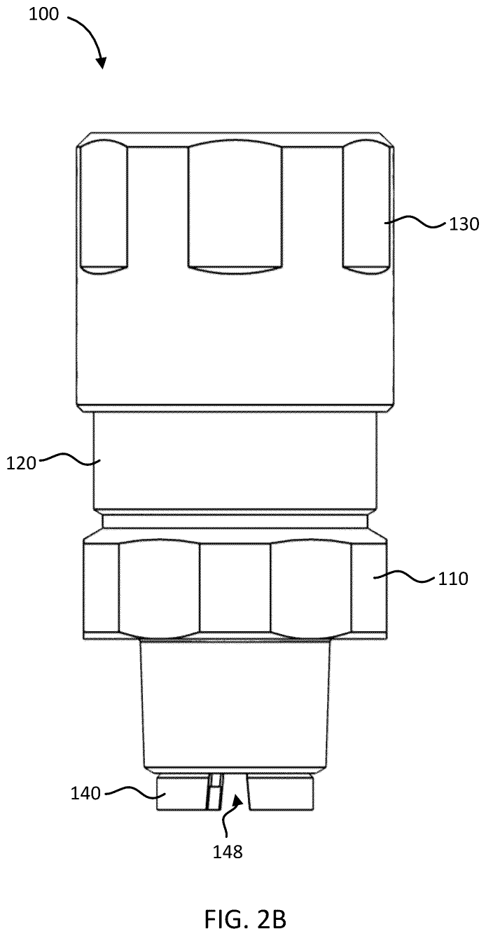

The cable gland 100 further includes an armor stop 140 removably engaged in the entry component 110. FIGS. 2A and 2B are side views of the cable gland 100 with the armor stop 140 in place. As shown in FIG. 2B, the armor stop 140 has a proximal end with at least one slot 148. The armor stop 140 has a channel with an inner diameter less than that of the entry component. The armor stop 140 therefore reduces a diameter of the central channel of the cable gland 100, particularly in the entry component 110, to accommodate smaller gauge or a small number of cables. When a larger gauge cable or more cables are used, the armor stop 140 can be removed via the lower opening of the entry component 110.

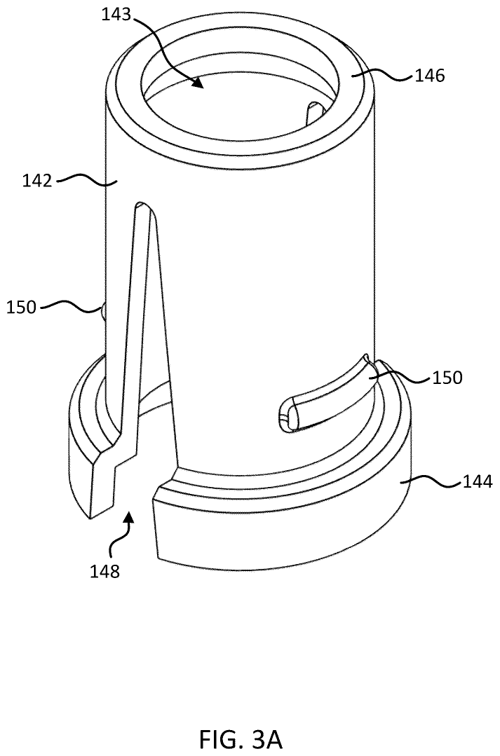

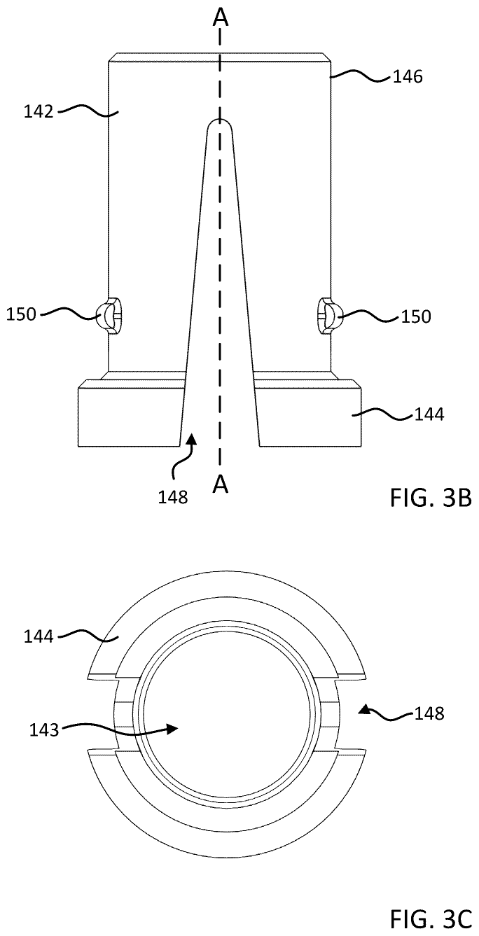

FIGS. 3A to 3C show the armor stop 140 removed from the cable gland 100 in an uncompressed state. The armor stop 140 has an elongated body 142 which is sized and shaped to be received in the entry component 110 of the cable gland 100. In the exemplary embodiment, the body 142 of the armor stop 140 is generally cylindrical in shape with a channel 143. The armor stop 140 has a proximal end 144, a distal end 146, and a central portion therebetween. The distal end 146 may have a chamfered edge to ease installation of the armor stop 140.

The proximal end 144 of the armor stop 140 may optionally have an outer diameter larger than the outer diameter of the body 142 of the armor stop 140. The difference in outer diameters defines a step between the proximal end 144 and the body 142. For example, in one embodiment, the outer diameter of the body 142 is approximately 13.8 mm and the outer diameter of 17.5 mm. However, the armor stop 140 can be made in various sizes and proportions to accommodate different applications.

The at least one slot 148 extends in an axial direction A from the proximal end 144 at least partially along a sidewall of the body 142 towards the distal end 146. In the exemplary embodiment, there are two slots 148 on opposite sides of the body 142 of the armor stop 140. Each slot 148 has a width which decreases in the axial direction A along the length of the slot 148. For example, in one embodiment, the slot 148 has a width of approximately 5 mm at the bottom and a width of approximately 1.5 mm at the top.

The armor stop 140 further includes at least one rib 150 on an outer surface of the body 142 for engaging at least one groove in the entry component 110. In the exemplary embodiment, the armor stop 140 has two ribs 150 on opposite sides of the body 142 of the armor stop 140. The ribs 150 may be elongated elements which each extend less than 180 degrees, preferably less than ninety degrees, around a circumference of the body 142. In the exemplary embodiment, each rib 150 extends less than fifty degrees, such as thirty degrees or less, around the circumference.

In the exemplary embodiment, the at least one rib 150 is positioned on a lower half of the outer surface of the body 142. In other embodiments, the armor stop 150 further includes one or more additional ribs 150 in a middle or upper portion of the outer surface of the body 142.

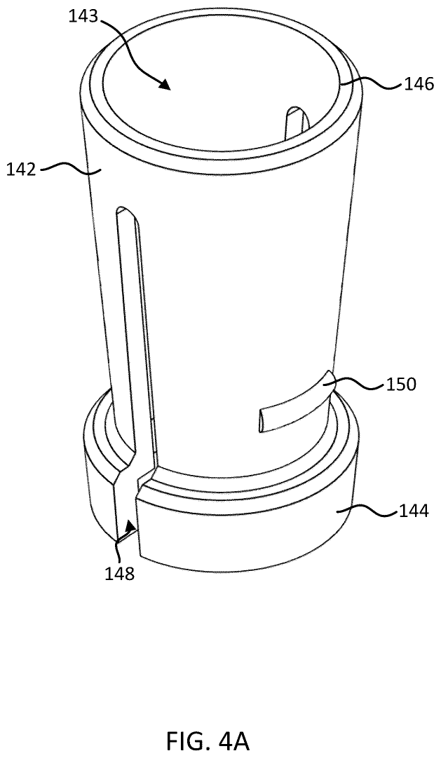

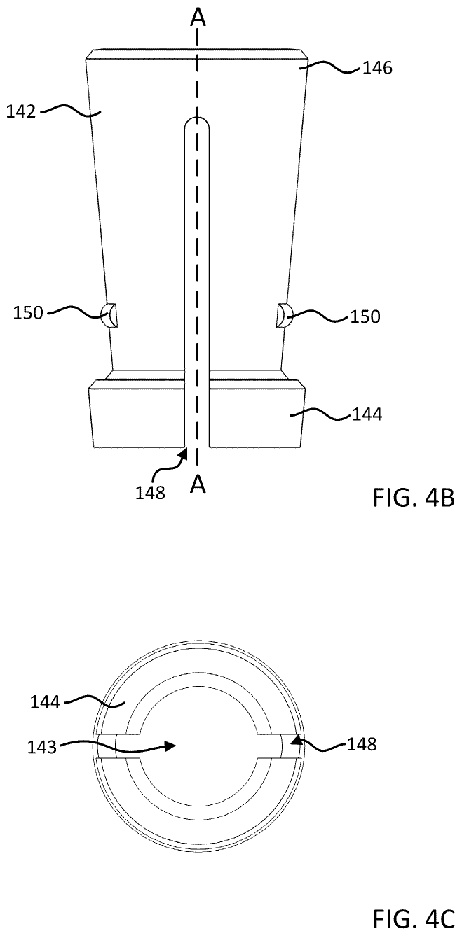

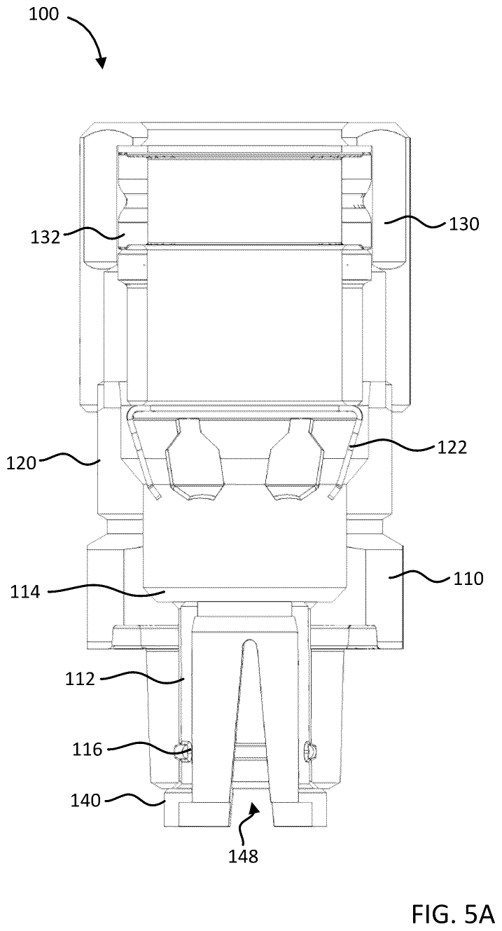

The armor stop 140 is compressible at its proximal end 144 by means of the slot 148. FIGS. 4A to 4C show the armor stop 140 removed from the cable gland 100 in a compressed state. Manually compressing the opposite sides of the proximal end 144 in a lateral direction (e.g., perpendicular to the axial direction A), e.g., by hand, reduces the outer diameter of the proximal end 144 and at least a portion of the body 142. For example, compressing the proximal end 144 may reduce the outer diameter of the proximal end by at least twenty-five percent (25%), such as thirty percent (30%) or more. Similarly, a distance between outer surfaces of the ribs 150 may be reduced by at least twenty-five percent (25%). In the compressed state, a diameter of the distal end 146 may remain the same and be greater than a diameter at a lower portion of the body 142.

The armor stop 140 is comprised of a material sufficient to enable to armor stop 140 to be at least partially flexible. In the exemplary embodiment, the armor stop 140 is comprised of a plastic material (e.g., nylon).

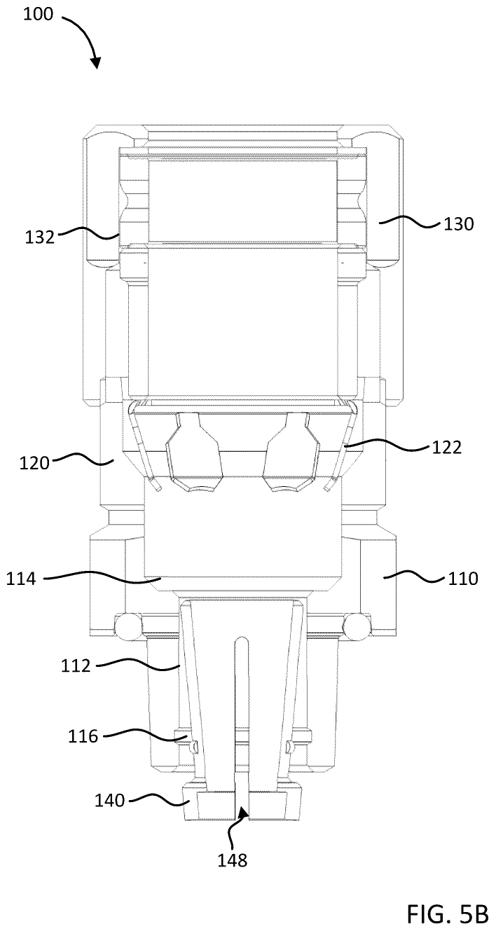

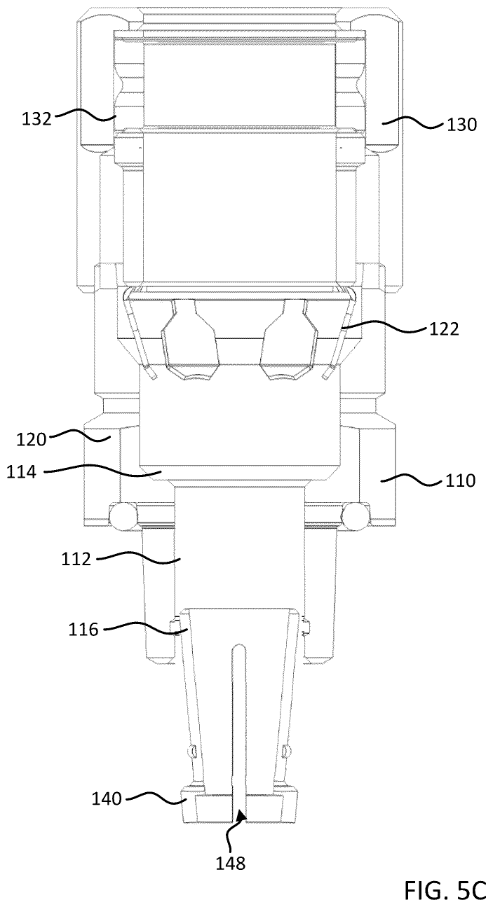

FIGS. 5A to 5C are cutaway views of the cable gland 100 illustrating how the armor stop 140 is removable from the cable gland 100. The armor stop 140 according to the present disclosure may be selectively inserted and removed via the lower opening of the entry component 110 without having to disassemble the cable gland 100.

FIG. 5A shows the cable gland 100 with the armor stop 140 in an uncompressed state installed in the entry component 110. The entry component 110 has a channel 112 with an upper edge 114 and an annular groove 116. The upper edge 114 may define an abutment. The annular groove 116 may have a curvature that is substantially the same as the rib 150. However, in some embodiments, a radius of curvature of the annular groove 116 is less than that of the rib 150 to provide an interference fit. In some embodiments, the middle nut 120 optionally includes a grounding device 122 with a plurality of fingers. The back nut 130 may include an ingress seal 132 compressible between the back nut 130 and the middle nut 120.

The armor stop 140 extends through the channel 112 and approximately up to the upper edge 114. The position of the arm stop 140 may be limited by the step defined by the proximal end 144 which engages against an outer surface of the entry component 110. The channel 143 of the armor stop 140 has an inner diameter less than an inner diameter of the channel 112 of the entry component 110. Thus, with the armor stop 140 in place, the diameter of the central channel of the cable gland 100 is reduced to accommodate smaller gauge or a small number of cables.

FIG. 5B shows the cable gland 100 with the armor stop 140 in a compressed state. Compressing the proximal end 144 of the armor stop 140 moves each of the ribs 150 inward to disengage the armor stop 140 from the groove 116. A user may compress the proximal end 144 of the armor stop 140 until the slot 148 is closed at the proximal end 144 or at least a sufficient amount to release the ribs 150 from the groove 116.

With the ribs 150 disengaged, the armor stop 140 is slidable out of the lower opening of the entry component 110 as shown in FIG. 5C. With the armor stop 140 removed, the cable gland 100 can accommodate a larger gauge cable or more cables. The armor stop 140 may be installed or reinstalled in the entry component 110 by at least partially compressing the proximal end 144 of the armor stop 140. Once in place, the armor stop 140 is self-retained in the entry component 110 via the at least one rib 150.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A cable gland, comprising:
an entry component including lower opening, an upper opening, and a channel defined between the lower opening and the upper opening; and
an armor stop removably engaged in the channel through the lower opening of the entry component, the armor stop having an elongated hollow body with a distal end, a proximal end, and at least one slot extending at least partially along a length of body;
wherein the proximal end of the armor stop is compressible, by means of the slot, in a lateral direction to insert and remove the armor stop from the lower opening of the channel.

2. The cable gland of claim 1, wherein the armor stop has at least one rib on an outer surface of the body.

3. The cable gland of claim 2, wherein the channel of the entry component includes an annular groove configured to receive the at least one rib.

4. The cable gland of claim 3, wherein the at least one rib includes a first rib on a first side of the armor stop and a second rib on a second side of the armor stop opposite the first side.

5. The cable gland of claim 2, wherein the at least one rib extends up to ninety degrees around a circumference of the outer surface of the armor stop.

6. The cable gland of claim 2, wherein the at least one rib extends up to fifty degrees around a circumference of the outer surface of the armor stop.

7. The cable gland of claim 2, wherein the at least one rib is positioned in a lower half of the body of the armor stop.

8. The cable gland of claim 1, wherein the slot has a width that decreases along a length of the slot from the proximal end of the body towards the distal end of the body.

9. The cable gland of claim 1, wherein the armor stop includes a channel extending from the proximal end to the distal end of the armor stop, wherein the channel of the armor stop has an inner diameter less than an inner diameter of the channel of the entry component.

10. The cable gland of claim 1, wherein the proximal end of the armor stop has an outer diameter greater than an outer diameter of a central portion of the body defining a step between the proximal end and the central portion of the body.

11. The cable gland of claim 1, wherein a diameter of the proximal end is compressible up to twenty-five percent.

12. The cable gland of claim 1, wherein the distal end of the armor stop includes a chamfered edge.

13. The cable gland of claim 1, further comprising a middle nut removably connected to the entry component.

14. The cable gland of claim 13, further comprising a back nut removably connected to the middle nut.

15. The cable gland of claim 14, further comprising an ingress seal compressible between the back nut and the middle nut.

16. An armor stop for a cable gland, comprising:
an elongated hollow body with a distal end, a proximal end, and at least one slot extending at least partially along a length of body;
wherein the proximal end of the armor stop is compressible, by means of the slot, in a lateral direction to insert and remove the armor stop from a lower opening of the cable gland.

17. The armor stop of claim 16, further comprising at least one rib on an outer surface of the body configured to engage within a corresponding annular groove within the cable gland.

18. The armor of claim 17, wherein the at least one rib includes a first rib on a first side of the armor stop and a second rib on a second side of the armor stop opposite the first side, each of the first rib and the second rib extending up to ninety degrees around a circumference of the outer surface of the armor stop.

19. The armor stop of claim 16, wherein the proximal end of the armor stop has an outer diameter greater than an outer diameter of a central portion of the body defining a step between the proximal end and the central portion of the body.
